(19) United States
(12) Patent Application Publication
(10) Pub. No.: US 2001/0017194 A1
(43) Pub. Date: Aug. 30, 2001

(54) Rear window roll-up blind

(76) Inventors: Werner P. Schlecht, Vaihingen (DE); Holger Seel, Aidlingen (DE); Herbert Walter, Ebersbach (DE)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(21) Appl. No.: 09/779,765

(22) Filed: Feb. 8, 2001

(30) Foreign Application Priority Data
Feb. 9, 2000 (DE) 10005951.1

(51) Int. Cl. B60J 1/20

(52) U.S. Cl. 160/370.22; 160/265

(57) ABSTRACT

A rear window roll-up blind for motor vehicles is provided which has a winding shaft that is rotatably supported preferably under the hat deposit area. A blind material can be drawn through a slot in the hat deposit area out which covers the window (3). For this purpose, an actuating member engages on the edge of the blind material (11) that covers the greatest distance. The actuating member is a linear-form element which can be either tension-resistant or pressure-resistant. The blind material itself can be held clamped-open beside the window with the aid of at least one guide rail or one or two pressure- or bending-resistant actuating members.

### FIELD OF THE INVENTION

The invention generally relates to roll-up blinds for use in motor vehicles.

### BACKGROUND OF THE INVENTION

A large number of solutions are known in order, with electrical remote control, to reel out and reel in a window roll-up blind arranged in the rear window pane of a passenger car.

One solution, for example, is shown in EP-C-0 240 747, in which bending-resistant levers are used exclusively for the clamping-open of the blind. The known rear window roll-up blind has a base in which a winding shaft is rotatably supported. The winding shaft is pre-stressed in winding-up direction with the aid of a spring motor which is mounted with one edge on the winding shaft. The other edge is connected with a drawbar on which two one-armed levers engage that are borne on the base. The bearing axes of the levers run at a right angle to the winding shaft. On the drawing-up of the levers, the blind material is drawn off from the winding shaft.

The known rear window roll-up blind is not suited for the rear window pane of station wagons and similar motor vehicles with a large rear shutter.

### OBJECTS AND SUMMARY OF THE INVENTION

Accordingly, in view of the foregoing, a general object of the present invention is to provide an electrically operable rear window roll-up blind that does not require any levers.

In the rear window roll-up blind of the invention, a rotatably supported winding shaft is provided to which a blind material is fastened at one border thereof. An actuating element engages a portion of the blind material lying away from the border connected to the winding shaft in order to draw the blind material off from the winding shaft and to hold it in the clamped-open or reeled-out state. For reeling-in and reeling-out the blind material, electrically actuated drive mechanisms are used.

In this manner, for example, the respective rear window roll-up blind can be controlled from the driver side. Moreover, the new construction makes it possible to let the rear window roll-up blind largely disappear underneath the hat deposit area or behind the door lining when the blind is used in a station wagon. In the reeled-in state, the blind is withdrawn virtually completely behind the contours of the window.

The winding shaft can be arranged, according to the space relations and the special form of the body work, either vertically, for example, in the rear shutter profile in the vicinity of the C-column of a passenger car, or parallel to the under-edge of the rear windows.

The mounting of the winding shaft laterally beside the window frame edge makes it possible, moreover, to accommodate the winding shaft in the area of the shutter where it does not collide with the window wiper motor.

In order to keep the blind material free from fluttering and vibrating in the clamped-open state, and also to guide it during the reeling-out movement, in principle two solutions are available.

The first solution provides at least one guide rail that runs parallel to a border of the window. With the aid of this guide rail, a portion of the blind material lying away from the winding shaft is guided in a fettered state.

The other possibility is to use substantially bending-resistant thrust members as actuating mechanisms, in order to draw the blind material off from the winding shaft. The thrust members engage the blind material edge which covers the greatest distance in the reeling-in and reeling-out. At least during the unwinding process, the front edge of the blind material is guided exclusively by the thrust members, and held in transverse direction. The thrust members, therefore, at least in a direction perpendicular to a plane that is defined by the clamped-open or reeled-out blind material, must be adequately resistant to bending. In a direction parallel thereto, guidance is supplied largely by the blind material itself in connection with the pre-stressing, thus a special bending resistance is not absolutely necessary in this direction.

In the completely clamped-open or reeled-out state, the upper edge of the blind material can be received in hook-shaped pockets. These pockets prevent vibrations of the upper edge of the clamped-open blind material resulting from jolting of the vehicle. Such vibrations can also be largely avoided if the thrust members are aligned in such manner that the upper edge of the blind material slides on the inner side of the pane, because it is being pressed against the pane.

A very stable guidance of the blind material is produced if the blind material is guided between two guide rails which run, proceeding from the winding shaft, in about the same direction. Since these guide rails do not run parallel to one another because of the rear window geometry, the blind material contains at least one tilt holder, which is adjustable in length. The tilt holder fits itself automatically to the changing distance between the guide rails.

The upper or rear edge of the blind material can also be taken up on an arm that is fastened to a slide running in the guide rail. The arm runs parallel to the respective edge of the window and guides the respective edge of the blind material virtually over its entire length.

Bending of the blind material can be avoided if the arm is constructed as a rail in which the respective blind material edge is slidably received.

In order to make the actuation and control of the blind material as simple as possible, the drive mechanism of the rear window roll-up blind of the invention comprises at least one electric motor as well as spring mechanisms. Between the electric motor and the spring mechanisms there lies kinematically the blind material, the drive motor defining the position of the upper or side edge of the blind material, while the spring mechanisms serve as a “slave drive” for pre-stressing of the blind material.

Depending on installation relations, the electric motor can cooperate with the winding shaft or with the portion of the blind material which covers the greatest distance in the reeling out, while the spring mechanisms engage in each case on the other end of the blind material. If the electric motor is operatively connected directly with the winding shaft, then the part of the blind material that covers the greatest distance is connected with a draw spring in the form of cables, over the actuating mechanisms. This makes it possible, inter alia, to compensate for different running distances of the actuating mechanisms in a simple manner if, for example, one actuating mechanism runs in a straight line and the other in curved guide-rails.

In the another embodiment, the spring is seated as a spring motor in the winding shaft, while the electric motor is coupled, over the actuating mechanisms, with the blind material and, namely, with the portion of the blind material which again covers the greatest distance in the winding and unwinding of the blind.

The actuating mechanisms can act, depending on the installation relations, as thrust members or as tension members. In both cases, Bowden cables can be used, while in the case of the pressure members the core of the Bowden cable must be executed or guided correspondingly resistant to pressure.

At least one end of the linear-form actuating members are provided with a type of gear with which they engage positively into an output gear wheel of the drive motor. Such actuating members are commercially available under the trade name “SU-flexwelle” and consist of a wire core running in lengthwise direction, on the outer peripheral surface of which there is applied a threaded element or screw likewise formed from a wire. The distance between adjacent turns of the screw corresponds to the thickness of the tooth of the drive gear wheel. In order to avoid rattling noises, between the wire turns of the threaded element or screw, bristles can be provided which give the arrangement the appearance of a bottle brush.

These and other features and advantages of the invention will be more readily apparent upon reading the following description of preferred exemplary embodiments of the invention and upon reference to the drawings wherein:

### BRIEF DESCRIPTION OF THE DRAWINGS

FIG. 1 is a partially cut away perspective view of the rear window pane of an illustrative passenger vehicle having a roll-up blind in accordance with the present invention.

FIG. 2 is a schematic partially exploded perspective view of the rear roll-up blind of FIG. 1.

FIG. 3 is a schematic partially exploded perspective view of an embodiment of a rear roll-up blind similar to the embodiment of FIG. 2, in a schematic perspective representation.

FIG. 4 is a schematic front elevation view of an embodiment of the rear roll-up blind which does not include guide rails.

FIG. 5 is a schematic front elevation view of an embodiment of the rear roll-up blind which has two guide rails.

FIG. 6 is an enlarged schematic view of the tilt holder showing its reception into the guide rails.

FIG. 7 is a schematic front elevation view of an embodiment of the rear roll-up blind of the present invention intended for use in a station wagon that is similar to that according to FIG. 5, but which has vertically arranged winding shaft.

FIG. 8 is a schematic partial perspective view of the lower guide rail of the rear roll-up blind according to FIG. 7.

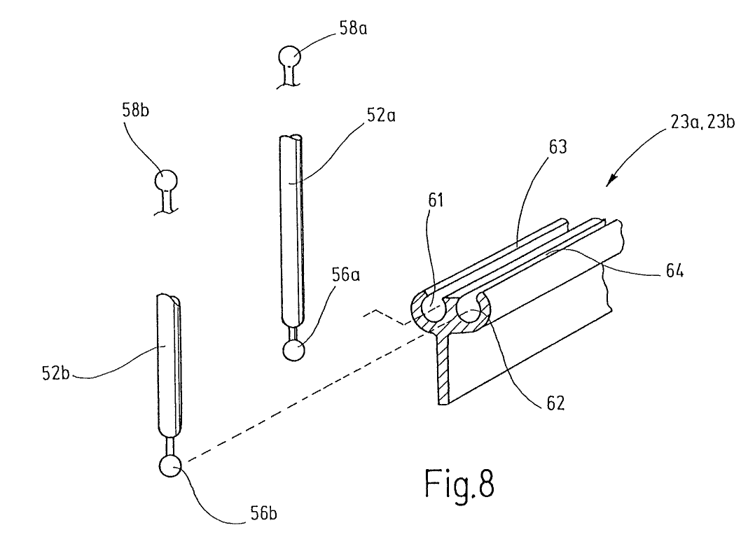

While the invention will be described and disclosed in connection with certain embodiments and procedures, it is not intended to limit the invention to those embodiments. Rather it is intended to cover all such alternative embodiments and modifications as fall with the spirit and scope of the invention.

### DETAILED DESCRIPTION OF PREFERRED EMDODIMENTS

In the following description of the figures terms such as “front”, “rear”, “above” or “below” as well as similar terms, inclusive of the terms “to the right” and “to the left”, are used in the manner in which they are usually used for the designation of direction on a motor vehicle.

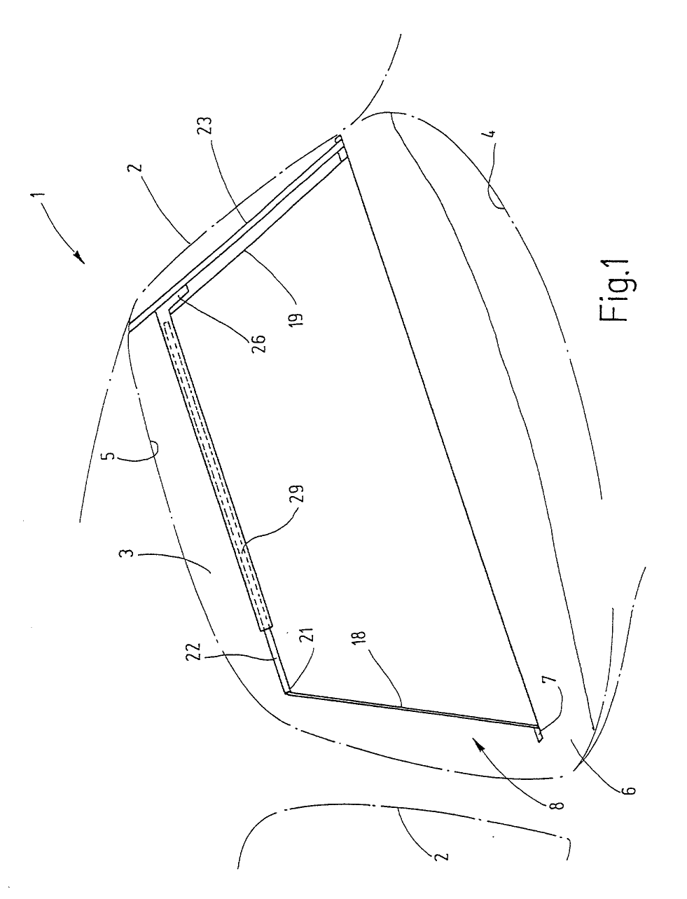

In FIG. 1, the rear portion of a motor vehicle 1 is schematically shown with a left and a right C-column. Between the C-columns, a rear window pane 3 extends from a lower edge 4 to a rear roof edge 5. In front of the rear window pane 3, a hat deposit area 6 is located which has a slot 7 running over its entire width. Further, a roll-up blind 8, which is shown in FIG. 1 in the reeled-out position, can be seen in the interior of the motor vehicle 1.

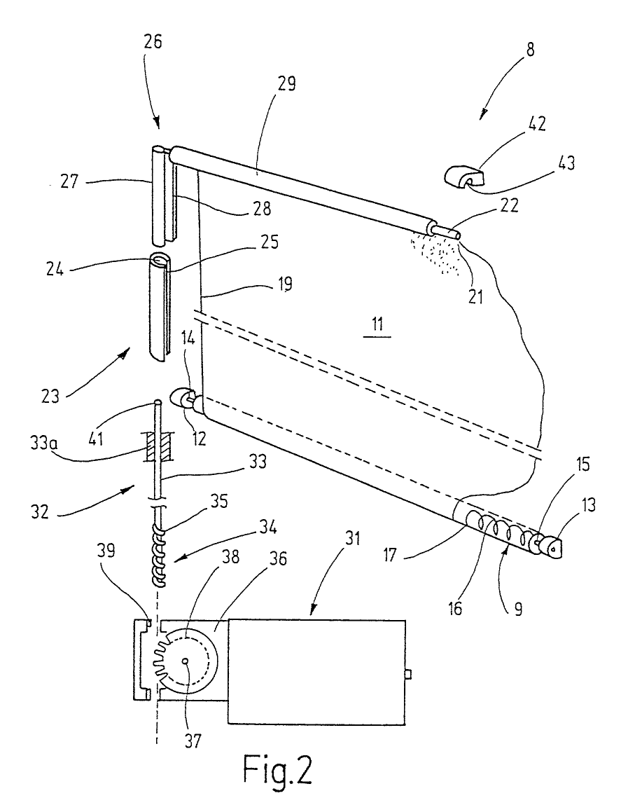

As shown in FIG. 2, the rear window roll-up blind 8 includes a winding shaft 9 which rotatably supported underneath the hat deposit area 6 and a blind material 11.

For supporting the winding shaft 9, bearing blocks 12 and 13 are provided on the underside of the hat deposit area 6 beside the slot 7. The bearing blocks receive bearing pins 14 and 15 which project axially from the tubular winding shaft 9. In the winding shaft 9, a schematically illustrated spring motor 16 is provided, which in 17 is firmly joined with the winding shaft 9, and the other end of which is coupled non-rotatably to the bearing pin 15. The bearing pin 15, in turn, is seated non-rotatably in the bearing block 13. The spring motor 16 forms a part of the drive arrangement of the rear window roll-up blind 8 and generates a pre-stressing force in the direction of winding-up or reeling-in the blind material 11 onto the winding shaft 9. To this end, the blind material 11 is fastened to the winding shaft 9 for example by piping mechanisms in a known manner.

The blind material 11 consists of a trapezoidal cut-out of a plastic foil, which sufficiently shields out the sunlight.

The blind material 11 is bounded by a left and a right side edge 18, 19, as well as an upper edge 21 and an edge (not shown) fastened to the winding shaft 9.

A border reinforcement strip 22 is mounted on the upper edge 21 which consists of a plastic profile, which extends from the left to the right side edge 12, 13.

The rear window roll-up blind 8 further includes a single guide rail 23 which, starting from the blind slot 7, extends to the roof rear edge 5 and is fastened there. The guide rail runs beside the right C-column 2 about parallel to this. A second guide rail is not present in this embodiment.

In FIG. 2 only a section of the guide rail can be seen. The guide rail 23 consists of a C-shaped profile with a back-gripping guide groove 24. The guide groove 24 opens on a slot 25 in the direction toward the blind material 11.

A slide 26 runs in the guide groove which consists of a base body 27 mounted on the inner space of the guide groove 24, from which base body a strip-form flange 28 proceeds, which extends to the outside through the slot 25. In the simplest case, the base body 27 is essentially cylindrical and the interior of the guide groove rail 23 is likewise cylindrical.

An extension 29 is fastened to the flange 28, which stands out essentially at a right angle and has the shape of a guide rail in which the border reinforcement strip 22 is received longitudinally slidably. The extension 29 is formed in such manner that the border reinforcement strip 22 has only one degree of freedom, namely in the direction parallel to the longitudinal extent of the extension 29. In the direction perpendicular thereto the reinforcement strip 22 is captured in the extension 29.

In order to reel the rear window roll-up blind 8 in and out at will, the drive arrangement includes, in addition to the spring motor 16, a gear motor 31 which is coupled with the slide 26 over an actuating member 32. The actuating member 32 is formed by a pressure-resistant, linear-shaped element, for example a flexible metal or plastic wire 33, the core of a Bowden cable or a thrust-resisting, cabled wire strand. At least on its motor-side end, the actuating member 32 carries a wire winding 35 forming a screw or worm 34 on its outer circumferential surface, which is unshiftably joined with the actuating member 32. Actuating members of this type are available under the trade name “SU-flexwelle” and are used, inter alia, in window-sash lifters.

The drive motor 31 is a permanently energized direct current motor having a reducing gear 36 arranged on the outlet side. On an output shaft 37 of the gear 36, a face gear wheel is untwistably seated, the division of which agrees with the division of the worm or screw 34.

Beside the face gear wheel 38, the housing of the gear 36 includes a guide 39 which is formed in such manner that it guides the screw 34 of the actuating member 32 tangentially to the output gear wheel 38 and allows the teeth of the face gear wheel 38 to positively engage between the turns of the screw 34.

The actuating member 32 connects the face gear wheel 38 operatively with the slide 26, and, namely, starting from the gear 36 or the guide 39 present there, it is led pressure-resisting in a sleeve 33a to the lower end of the guide rail 23. Here, the actuating member 32 enters the interior of the guide groove 24. The free end 41 of the actuating member 32 lies in freely abutting relationship on the lower end of the guide slide 26.

In the installed state with rear window roll-up blind 8 opened, only the guide rail 23 can be seen. The guide rail 23 runs beside the right window edge, and therefore largely disappears. Only the extension 29 could possibly be seen in the slot 7, through which the blind material 11 is reeled out in upward direction.

An example of the handling and functioning of the rear window roll-up blind 8 of the invention is as follows:

In the rest state, the blind material 11 is wound under the action of the spring motor 16 around the winding shaft 9. The slide 26 has traveled downward in the guide rail 23 until the extension 29 fills the earlier-mentioned blind slot 7 that corresponds to the length of the extension 29.

When the user, starting from this operative position, wishes to reel out the rear window roll-up blind 8, he uses an electric switch to set the drive motor 31 in operation in a turning direction such that the face gear wheel 38 moves the pressure resistant or pressure-resistantly guided actuating member 32 forward, in the direction toward the guide rail 23. During this advancing movement, the actuating member 32 guided in the interior of the guide rail 23 presses the guide slide 26 upward, together with the extension 29 to which it is fastened, in the direction toward the rear edge 5 of the roof. There the blind material 11 is correspondingly unwound from the winding shaft 9 and drawn upward through the blind slot 7 in the hat deposit area 6.

As soon as the slide 26 arrives at the upper end of the guide rail 23 and strikes against corresponding boundary stops, the motor current rises, which is evaluated in a known manner by a monitoring circuit, in order to switch off the current of the drive motor 31, independently from the switch control by the user. The arrangement further provides for re-engaging of the motor current only for the reversed turning direction in a known manner.

The blind material 11 is now completely reeled out and the extension 29 strikes against the upper window frame edge 5. In front of the entire window surface, the blind material 11 is clamped open.

Even if, as shown, the angle between the guide rail 23 and the axis of the winding shaft 9 does not amount to 90°, distortions can not occur in the blind material 11, because the border reinforcement strip 22 can move in the extension 29 over at least a certain distance.

Vibration of the extension 29 with the reeled-out rear window roll-up blind 8 can be avoided if, in correspondence to its upper end position a hook-shaped pocket 42 is fastened to the upper edge of the rear window 3. The pocket 42 further contains a downward-open groove 43 which receives the extension 29 in the upper end position in a place which is spaced from the slide 26. Oscillating movements of the extension 53 about the long axis of the slit 49 are thereby precluded with certainty.

For reeling-in of the rear window roll-up blind 8, the user sets the electric motor over a corresponding switch in the opposite turning direction. The face gear wheel 38, which meshes with the screw 34, draws the actuating member 32 back downward from the guide rail 23, whereby the forward-thrust force acting against the slide 49 lets up. The spring motor 16, thereby, is in a position corresponding to the yielding of the actuating member 32, to wind the blind material 13 again onto the winding shaft 9.

The lower end position of the actuating member can be called up in a similar manner to the upper end position, and it can be halted in a corresponding manner.

As is evident, the blind material 11 is held tensioned by the action of the spring motor 16, while the position is given by the drive motor 31 acting self-inhibitively.

As can be seen from the explanation, the spring drive 16 could also change places with the drive motor 31 in such manner that the drive motor 31 drives the winding shaft 9 positively, while the actuating member 32 is acted upon by a pressure spring, or such a spring is replaced. In such an embodiment, the slide 26 would be pre-stressed in the unwinding direction, while the blind material 11 is wound onto the winding shaft 9 against the action of the spring 16.

Finally, it would also be conceivable to use a cable as actuating member 32 which is fastened at one end to the slide 26 and at the other end to a draw-spring. The draw spring would likewise tend to draw the slide 26 upward, over the cable, in which process the movement would be hampered or freed by the interplay of the winding shaft 9 with the drive motor 31.

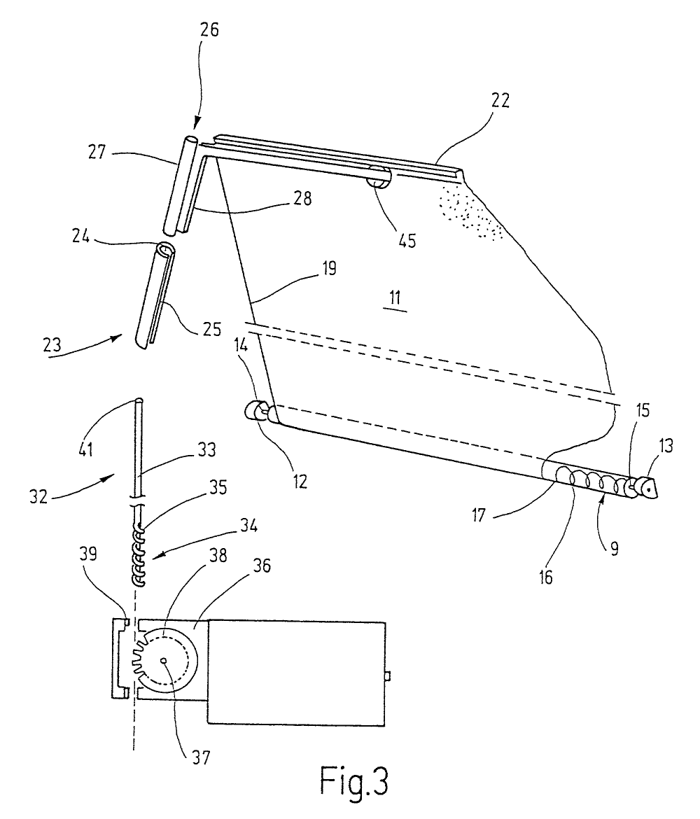

In FIG. 3, a rear window roll-up blind 8 is shown which has a very similar construction to that of the rear window roll-up blind 8 according to FIG. 2. The essential difference lies in the border reinforcement strip 22 which is formed by a downward-open U-shaped strip. In the strip 22, a roller 45 runs which is rotatably borne on the free end of the extension 29. With this arrangement, it is possible not only as in the embodiment according to FIG. 2, to compensate for a displacement of the border reinforcement strip 22 parallel to the extension 29, but also to compensate for a change in the angle.

Because of the course of the particular window frame edge, such a change in the angle arises when the guide rail 23 does not run in a curve. For this reason, the slide 26 in the guide rail 23 imposes a direction on the extension 29 in which, in dependence on position, it encloses an angle with the winding shaft 9 which is different from zero and which changes steadily from it in the movement of the blind material 11.

The kinematic reversal would likewise be possible, inasmuch as the roller 45 is mounted on the border reinforcement strip 22, while the extension 29 has an upward opening U-shaped profile.

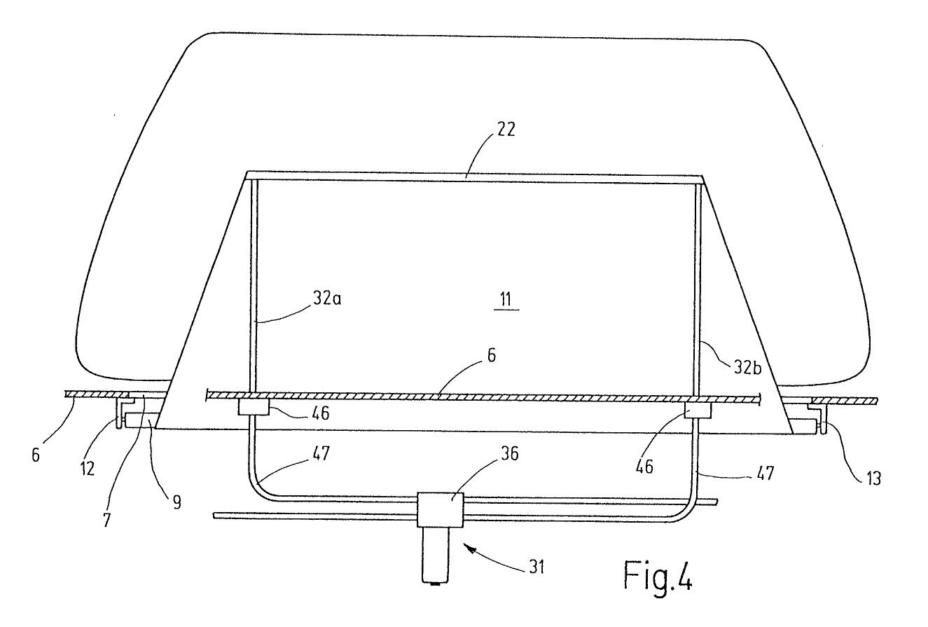

In the earlier described embodiments, the rear window roll-up blind 8 has a single guide rail 23. In FIG. 4, an embodiment in which the rear window roll-up blind 8 is free from guide rails is shown highly schematically.

As before, underneath the hat deposit area 6 the winding shaft 9 is rotatably supported. The blind material 11 is fastened to it, with an edge as described before, the shape of which is formed about as shown in FIG. 1.

Literally beside the winding shaft 9, under the hat deposit area 6, with spacing from one another, two slide guide blocks 46 are fastened. From each one of the slide guide blocks 46, a pressure-resistant and relatively bending-resistant cylindrical actuating member 32a and 32b arises. The lower ends of the two actuating members 32a and 32 are formed in the same manner as is explained in connection with FIG. 2 and, starting from the slide guide blocks 46, they extend through guide tubes 47 to the drive motor 31 and into its gear 36. Since both actuating members 32a, 32b are driven by the same face gear wheel 38, they run necessarily with the same speed and the same stroke, i.e. exactly synchronously to one another.

The free ends of the actuating members 32a and 32b are directly connected with the reinforcing strip 22.

During the reeling-out, the actuating members press the reinforcing strip 22 upward and thereby, against the action of the spring motor in the winding shaft 9, they unwind the blind material from the winding shaft 9.

The part of the actuating members 32a and 32 emerging from the slide guide blocks 46 is a relatively rigid plastic or metal wire which, on the one hand, can follow the arcuate course of the guide tubes 47, but, on the other hand, is capable of carrying the reinforcing border strip 22 of the blind material 11 and of pressing again the rear window pane 3.

The free ends of the actuating members 32a and 32b are rigidly joined with the border reinforcement strip 22.

The function of the rear window roll-up blind 8 according to FIG. 4 is similar to that in the earlier-explained rear window roll-up blind 8 according to FIGS. 1 to 3. The sole difference lies in that the border reinforcement strip 22 is carried and guided exclusively by the actuating members 32a and 32b. It is obvious that these actuating members 32 run parallel to one another in the reeled-out state.

So that in the reeled-out state the upper edge of the blind material 11 does not start vibrating because of the inevitably occurring jarring, one or two receiving pockets 42 can be provided, as shown in FIG. 2 and also described in connection with FIG. 2.

The winding of the blind material 11 on the winding shaft 9 takes place as described above, for example with the aid of a spring motor 16 accommodated in the winding shaft 9.

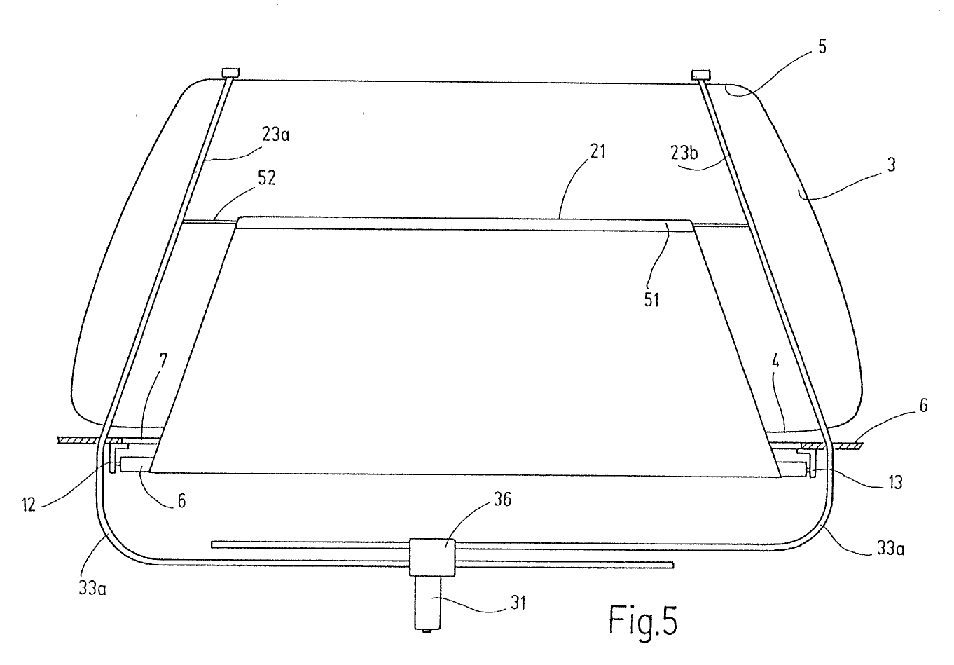

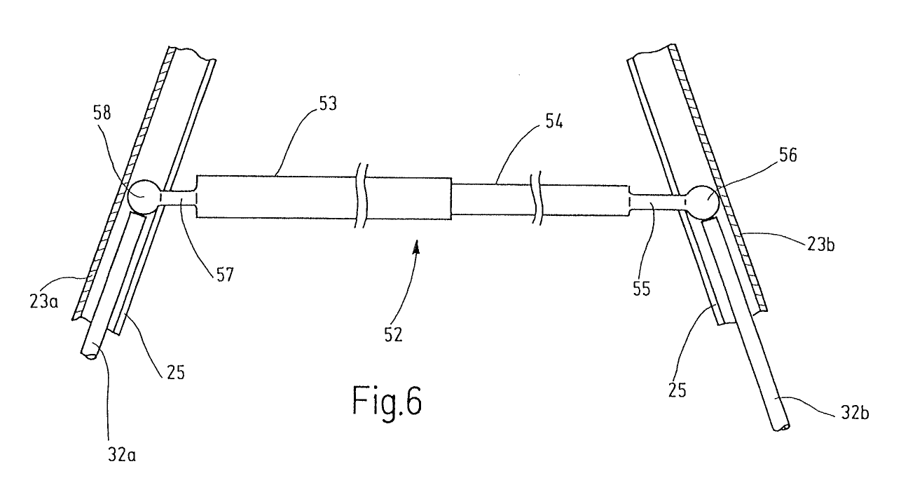

An embodiment for a rear window roll-up blind 8 which has two guide rails 23a and 23b is shown in FIGS. 5 and 6. The guide rails 23a and 23b have the same cross-section shape as thoroughly explained already in connection with FIG. 3. The guide rail 23a runs in an essentially straight path corresponding to the course of the right window frame edge, while the guide rail 23b is aligned parallel to the left rear window edge.

In order to guide the blind material 11 faultlessly between these two guide rails 23a and 23b, the blind material 11 contains on its upper edge 21 a flexible tubular pocket 51 which lies parallel to the winding shaft 9. A tilt holder 52 leads through the pocket 51 that is shown in detail in FIG. 6, which (figure) also makes evident the cooperation with the guide rails 23.

The tilt holder 52 is composed of two movable tilt holder members 53 and 54 movable telescopically with respect to one another. The tilt holder member 53 is a cylindrical tube in which the tilt holder piece 54 is guided longitudinally slidable relation. On its free end, the tilt holder piece 54 goes over into a cylindrical neck 55 which projects through the slot 25 and carries a ball 56 on its free end. The ball 56 corresponds in its diameter to the diameter of the clear inner space of the guide groove 24 of the guide rail 23b.

The left end of the tilt holder member 53 likewise goes over into a neck 57 which is provided with a ball 58 on its free end. The ball 58 runs in the interior of the guide rail 23a and like the ball 56 it is locked therein, i.e. it cannot emerge from the slot 25.

An actuating member 32a or 32b runs in each of the two guide rails 23a and 23b, respectively, the diameter of which is greater than the width of the respective slot 25, wherewith the actuating members 32 are compelled to follow the course of the guide rails 23.

The winding shaft 9 with its support is again designed as in the earlier described embodiments.

For reeling out the blind material 11, the motor 31 is started, which thereupon thrusts the actuating members 32a and 32b upward in the respective guide rails 23a and 23b and they both come into engagement respectively with the ball 58 and also with the ball 56 lying directly adjacent. The tilt holder 52 is steadily aligned parallel to the winding shaft 9, and thrust away from the winding shaft 9.

In the area of the winding shaft 9, the two guide rails 23a and 23b are at the greatest distance from one another, for which reason the tilt holder 52 is drawn correspondingly into the length, and projects from the tubular pocket 51. As the blind material 11 approaches the drawn-out end position, the closer its upper edge 21 approaches the guide rails 23a and 23b. The tilt holder 52 is correspondingly shortened. In the end position, the blind material 11 completely fills the space between the guide rails 23a and 23b and therewith also shades off the respective rear window 3.

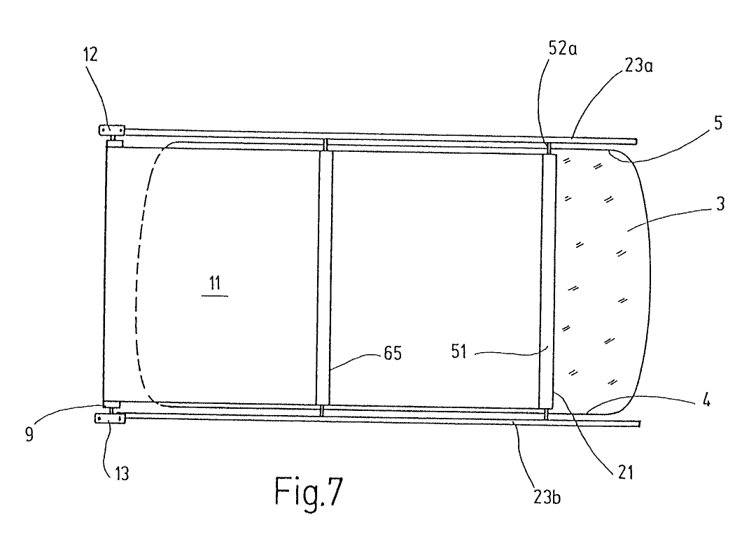

While in the example according to FIG. 5, as shown, the winding shaft 9 runs parallel to the lower window edge, FIG. 7 shows an embodiment in which the winding shaft 9 is vertically aligned and, accordingly, lies parallel to the C-column 2. It is an embodiment which is preferred in the case of rear doors.

Here, too, again two guide rails 23a and 23b are used. The guide rail 23a extends parallel to the lower window edge 4, while the upper guide rail 23b follows the course of the upper window edge 5.

The cross section shape of the two guide rails 23a and 23 is the same, but it differs from the profile of the guide rails 23 of the previous embodiments.

The guide rails 23a and 23b contain two back-gripping grooves, respectively 61 and 62, that are continuous in the longitudinal direction. The grooves 61 and 62, respectively, open outward over a continuous groove slot 63 and 64, respectively, toward the blind material 11. Two tilt holders 52a and 52b run in these grooves 61, 62.

The tilt holders 52a and 52b have the same appearance as the tilt holder 52 according to FIG. 6 for the rear window roll-up blind 8 according to FIG. 5. A renewed explanation, therefore, is omitted.

The blind material 11 contains, in addition to the tubular pocket 51 on the front edge 21, still a further tubular pocket 65, about in the middle of the extended length of the blind material 11. The pocket 65 runs parallel to the winding shaft 9. The pocket 65 receives the tilt holder 52b and the pocket 51 receives the tilt holder 52a.

For reeling out the blind material 11, separate actuating members (not shown) are present for the upper guide rail 23a and the lower guide rail 23b. The actuating members run in the same grooves in which the tilt holder 52a of the front edge 21 is guided and which lies further away from the winding shaft 9 as in each case the other groove 62.

For reeling-out of the blind material 11, the drive motor is started and the actuating members are thrust forward in the groove 61 of the two guide rails 23a and 23b, in the direction toward the left side of the vehicle. There the balls of the tilt holders 52a are carried along and above them the front edge 21 of the blind material 11.

In the rest state, the blind material 11 is virtually completely wound on the winding shaft 9. Also the pocket 65 with the tilt holder 52b is present in the wound-up bale and only the tilt holder 52a remains in its guide groove 61.

As soon as the tilt holder 52a has been correspondingly advanced and the tilt holder 52b begins to run off from the winding shaft 9, by a threading arrangement (not shown) it is provided that the balls 56b and 58b seated on the two ends of the tilt holder 52b are threaded into the guide grooves 62.

In this manner, the blind material 11 is supported or guided also in the middle in the drawn-out state and can vibrate less. On the other hand, the tilt holder 52b serving for the support does not hamper the winding-up.

The combination of disclosed features which are used are at the option of the designer and it depends above all on the prevailing side constraints, such as window size, window proportions and window geometry, space in the rear interior lining or underneath the hat deposit area, and the like. Moreover, it is obvious that the rear window roll-up blinds shown are in no way restricted to notchback limousines. The rear window roll-up blind of the invention can also be directly implemented if it is installed behind the lining of the C-column. Merely in order to limit the number of exemplary embodiments to a reasonable degree, selected combinations of features are represented and explained.

A rear window roll-up blind for motor vehicles has a winding shaft which is rotatably supported preferably under the hat deposit area. Through a slot in the hat deposit area, a blind material which covers the window can be drawn out. For this purpose, an edge of the blind material which covers the greatest distance engages an actuating member. The actuating member is a linear-form element which, depending on the embodiment, is either tension-resistant or pressure-resistant. The blind material itself can be clamped open beside the window with the aid of at least one guide rail, or of one or two pressure or bending resistant actuating members.

1. A roll-up blind for a rear window of a motor vehicle, the rear window being bounded by an approximately horizontally extending lower window frame edge, two approximately vertically extending lateral window frame edges and an approximately horizontally extending upper window frame edge, the roll-up blind comprising:
a rotatable winding shaft,
a blind material that is movable between a reeled-in position and a reeled-out position and at least a portion of which corresponds least approximately to the shape of the rear window, the blind material having an outer peripheral border with a first portion that is fastened to the winding shaft and a second portion that lies away from the winding shaft,
an actuating mechanism which is connected with the second portion of the outer peripheral border of blind material, and
an electrically operable drive mechanism for moving the blind material between the reeled-in position and the reeled-out position.

2. A rear window roll-up blind according to claim 1, wherein the winding shaft is arranged laterally beside one of the lateral window frame edges.

3. A rear window roll-up blind according to claim 1, wherein the winding shaft is arranged so as to extend horizontally underneath the lower window frame edge.

4. A rear window roll-up blind according to claim 1, further including one guide rail.

5. A rear window roll-up blind according to claim 1, further including two guide rails.

6. A rear window roll-up blind according to claim 4, wherein the guide rail is arranged to extend horizontally.

7. A rear window roll-up blind according to claim 4, wherein the guide rail extends parallel to the lower window frame edge.

8. A rear window roll-up blind according to claim 1, wherein the guide rail is arranged so as to extend laterally beside one of the lateral window frame edges.

9. A rear window roll-up blind according to claim 4, wherein the guide rail extends parallel to one of the lateral window frame edges.

10. A rear window roll-up blind according to claim 1, wherein the roll-up blind does not include guide rails.

11. A rear window roll-up blind according to claim 1, wherein the blind material includes a border reinforcing element in the second portion of the outer peripheral border.

12. A rear window roll-up blind according to claim 11, wherein the border reinforcing element is flexible.

13. A rear window roll-up blind according to claim 11, wherein a portion of the border reinforcing element is rigid.

14. A rear window roll-up blind according to claim 11, wherein a portion of the border reinforcement serves as drawbar.

15. A rear window roll-up blind according to claim 4, wherein the blind material includes a tilt holder having an end side guided in the guide rail.

16. A rear window roll-up blind according to claim 16, wherein the tilt holder is guided has two end sides each of which is guided in a guide rail.

17. A rear window roll-up blind according to claim 16, wherein the tilt holder is telescopically adjustable in length.

18. A rear window roll-up blind according to claim 4, further including a slide which is guided in the guide rail and an extension that is fastened to the slide, the second portion of the outer peripheral border of the blind material being connected to the extension.

19. A rear window roll-up blind according to claim 18, wherein the second portion of the outer peripheral border of the blind material is connected in longitudinally slidable relation with the extension.

20. A rear window roll-up blind according to claim 1, wherein the actuating mechanism includes a linear-form pressure member which is guided a sleeve so as to be resistant to pressure.

21. A rear window roll-up blind according to claim 1, wherein the actuating mechanism includes a bending-resistant rod which has a free end that is connected with the outer peripheral border of the blind material and which is guided so as to be longitudinally slidable in a fixed guide arrangement in a direction substantially at a right angle to a longitudinal axis of the winding shaft.

22. A rear window roll-up blind according to claim 21, wherein the bending-resistant rod is coupled with a linear-form pressure member.

23. A rear window roll-up blind according to claims 19, wherein the actuating mechanism includes a linear-form pressure member and the linear-form pressure member is coupled with the slide.

24. A rear window roll-up blind according to claims 16, wherein the actuating mechanism includes a linear-form pressure member that is coupled with the tilt holder.

25. A rear window roll-up blind according to claim 20, wherein the linear-form pressure member includes a gear at one end thereof which positively couples the linear-form pressure member with a gear wheel of a drive motor.

26. A rear window roll-up blind according to claim 1, wherein the actuating mechanism includes a cable.

27. A rear window roll-up blind according to claim 1, wherein the drive mechanism includes a spring.

28. A rear window roll-up blind according to claim 27, wherein the spring comprises a spring motor coupled with the winding shaft which pre-stresses the winding shaft in a direction so as to move the blind material towards the reeled-in position.

29. A rear window roll-up blind according to claim 27, wherein the spring is connected through the actuating mechanism with the blind material and the spring pre-stresses the blind material towards the reeled-out position.

30. A rear window roll-up blind according to claim 1, wherein the drive mechanism includes a gear motor.

31. A rear window roll-up blind according to claim 30, wherein the gear motor is coupled with the winding shaft.

32. A rear window roll-up blind according to claim 30, wherein the gear motor is coupled through the actuating mechanism with the blind material.
